(19) United States
(12) Patent Application Publication
(10) Pub. No.: US 2019/0241400 A1
(43) Pub. Date: Aug. 8, 2019

(54) ELEVATOR CONTROL SYSTEM AND ELEVATOR CONTROL METHOD FOR EVACUATION

(71) Applicant: Otis Elevator Company, Farmington, CT (US)

(72) Inventors: Kai Zhang, Shanghai (CN); Hui Fang, Shanghai (CN); Jie Xi, Shanghai (CN); Zhen Jia, Shanghai (CN); Zhenggang Zhu, Shanghai (CN)

(21) Appl. No.: 16/270,031

(22) Filed: Feb. 7, 2019

(30) Foreign Application Priority Data
Feb. 7, 2018 (CN) 201810122449.3

(51) Int. Cl. B66B 5/02; B66B 1/36

(52) U.S. Cl. CPC B66B 5/021; B66B 1/36

(57) ABSTRACT

The present invention relates to an elevator control device and method for evacuation, pertaining to the field of elevator control technologies. The elevator control device and method of the present invention control, according to the occupant information and disaster information of a plurality of evacuation floors, stopping of an elevator car at at least one of the plurality of evacuation floors. The present invention makes the evacuation process of a plurality of evacuation floors more efficient and reliable.

### FOREIGN PRIORITY

This application claims priority to Chinese Patent Application No. 201810122449.3, filed Feb. 7, 2018, and all the benefits accruing therefrom under 35 U.S.C. § 119, the contents of which in its entirety are herein incorporated by reference.

### TECHNICAL FIELD

The present invention relates to the field of elevator control technologies, and in particular, to an elevator control device and method for evacuating occupants in a building and an elevator system using the elevator control device.

### BACKGROUND ART

As more high-rise buildings are being constructed, it is of great importance to safely, quickly, and effectively evacuate occupants in a building in the event of a disaster (for example, fire, earthquake, terrorist attack, etc.).

Currently, elevator systems are being used for evacuating or relocating occupants inside buildings, that is, used as an evacuation path or part of an evacuation path, thus increasing evacuation efficiency. For example, the American Society of Mechanical Engineers (ASME) has published Occupant Evacuation Operation (OEO) guidelines regarding how to control an elevator system to evacuate occupants in the event of a disaster. An elevator car of the elevator system travels back and forth, for example, in shuttle-bus mode, between an evacuation floor and a safe floor, and thus can transport occupants of the evacuation floor only to the safe floor.

### SUMMARY OF THE INVENTION

According to a first aspect of the present invention, an elevator control device for controlling the travel of one or more elevator cars of an elevator system is provided, where a control module of the elevator control device is configured to control, according to occupant information and disaster information of a plurality of evacuation floors, stopping of the elevator car at at least one of the plurality of evacuation floors.

According to an embodiment of the present invention, the elevator control device further includes: an occupant information acquiring unit configured to acquire the occupant information of the plurality of evacuation floors; and a disaster information acquiring unit configured to acquire the disaster information of the plurality of evacuation floors.

According to an embodiment of the present invention, in the elevator control device, the occupant information acquiring unit includes: an occupant information capturing component installed at a corresponding position on at least one of the plurality of evacuation floors and configured to capture image information of an area corresponding to the position; and an occupant information analyzing component configured to analyze image information captured by one or more occupant information capturing components to acquire the occupant information of the corresponding evacuation floor.

According to an embodiment of the present invention, in the elevator control device, the occupant information includes occupant quantity information, or further includes at least one of the following types of information: occupant distribution information, occupant flow information, and occupant feature information.

According to an embodiment of the present invention, in the elevator control device, the disaster information includes at least one of the following types of information: disaster type information, threat position information, disaster spreading information, and threat development trend information.

According to an embodiment of the present invention, in the elevator control device, the control module is further configured to dynamically adjust a stopping strategy for the elevator car corresponding to at least one of the plurality of evacuation floors according to real-time changes in the occupant information and the disaster information of the plurality of evacuation floors.

According to an embodiment of the present invention, in the elevator control device, the control module is configured to control the travel of the elevator car from a first evacuation floor for initial stopping to a safe floor, and is further configured to control, according to current occupant information and disaster information of the plurality of evacuation floors, whether the elevator car performs intermediate stopping at one or more second evacuation floors other than the first evacuation floor among the plurality of evacuation floors.

According to an embodiment of the present invention, in the elevator control device, the control module is further configured to: control, according to the current remaining capacity of the elevator car, the stopping of the elevator car at at least one of the plurality of evacuation floors.

According to an embodiment of the present invention, in the elevator control device, the control module is further configured to: when the current remaining capacity of the elevator car during initial stopping or intermediate stopping is greater than or equal to a first predetermined value, control the elevator car in continuing to stop for a first predetermined time period.

According to an embodiment of the present invention, in the elevator control device, the control module is further configured to: when the current remaining capacity of the elevator car after initial stopping is greater than or equal to a second predetermined value, control whether the elevator car performs intermediate stopping at the second evacuation floor at least based on occupant information and disaster information corresponding to the second evacuation floor.

According to an embodiment of the present invention, in the elevator control device, the control module is further configured to: respectively determine, based on real-time occupant information and disaster information corresponding to a plurality of second evacuation floors, priorities of the second evacuation floors for intermediate stopping.

According to an embodiment of the present invention, in the elevator control device, the control module is further configured to: determine, based on the priorities of the plurality of second evacuation floors for intermediate stopping, a second evacuation floor at which the elevator car needs to intermediately stop in the current process of traveling from the first evacuation floor for initial stopping to the safe floor, and/or determine, based on the priorities of the plurality of second evacuation floors for intermediate stopping, a sequence for intermediate stopping.

According to an embodiment of the present invention, in the elevator control device, the control module is further configured to: determine, based on real-time occupant information and disaster information corresponding to the plurality of evacuation floors, priorities of the plurality of evacuation floors as the first evacuation floor for initial landing.

According to an embodiment of the present invention, in the elevator control device, the control module is further configured to: determine a sequence of initial stopping based on the priorities for initial stopping.

According to a second aspect of the present invention, an elevator system is provided, including an elevator car and the elevator control device according to any one of the foregoing embodiments.

According to a third aspect of the present invention, an elevator control method for controlling the travel of one or more elevator cars of an elevator system is provided, where the method includes: controlling, according to occupant information and disaster information of a plurality of evacuation floors, stopping of the elevator car at at least one of the plurality of evacuation floors.

According to an embodiment of the present invention, the elevator control method further includes a step of: receiving the occupant information and the disaster information of the plurality of evacuation floors.

According to an embodiment of the present invention, in the elevator control method, the occupant information includes occupant quantity information, or further includes at least one of the following types of information: occupant distribution information, occupant flow information, and occupant feature information.

According to an embodiment of the present invention, in the elevator control method, the disaster information includes at least one of the following types of information: disaster type information, threat position information, disaster spreading information, and threat development trend information.

According to an embodiment of the present invention, in the elevator control method, a stopping strategy for the elevator car corresponding to at least one of the plurality of evacuation floors is dynamically adjusted according to real-time changes in the occupant information and the disaster information of the plurality of evacuation floors.

According to an embodiment of the present invention, in the elevator control method, in a process of controlling the travel of the elevator car from a first evacuation floor for initial stopping to a safe floor, the elevator car is controlled, according to current occupant information and disaster information of the plurality of evacuation floors, in whether to perform intermediate stopping at one or more second evacuation floors other than the first evacuation floor among the plurality of evacuation floors.

According to an embodiment of the present invention, in the elevator control method, the stopping of the elevator car at at least one of the plurality of evacuation floors is controlled according to the current remaining capacity of the elevator car.

According to an embodiment of the present invention, in the elevator control method, when the current remaining capacity of the elevator car during initial stopping or intermediate stopping is greater than or equal to a first predetermined value, the elevator car is controlled to continue stopping for a first predetermined time period.

According to an embodiment of the present invention, in the elevator control method, the first predetermined value is 10%-30% of the rated load of the elevator car.

According to an embodiment of the present invention, in the elevator control method, when the current remaining capacity of the elevator car after initial stopping is greater than or equal to a second predetermined value, the elevator car is controlled in whether to perform intermediate stopping at the second evacuation floor at least based on occupant information and disaster information corresponding to the second evacuation floor.

According to an embodiment of the present invention, in the elevator control method, the second predetermined value is 30%-50% of the rated load of the elevator car.

According to an embodiment of the present invention, in the elevator control method, based on real-time occupant information and disaster information corresponding to a plurality of second evacuation floors, priorities of the second evacuation floors for intermediate stopping are respectively determined.

According to an embodiment of the present invention, in the elevator control method, a second evacuation floor at which the elevator car needs to intermediately stop in the current process of traveling from the first evacuation floor for initial stopping to the safe floor is determined based on the priorities of the plurality of second evacuation floors for intermediate stopping, and/or a sequence for intermediate stopping is determined based on the priorities of the plurality of second evacuation floors for intermediate stopping.

According to an embodiment of the present invention, in the elevator control method, priorities of the plurality of evacuation floors as the first evacuation floor for initial landing are determined based on the occupant information and the disaster information corresponding to the plurality of evacuation floors.

According to an embodiment of the present invention, in the elevator control method, a sequence of initial stopping is determined based on the priorities for initial stopping.

According to a fourth aspect of the present invention, an elevator control device is provided, including a memory, a processor, and a computer program stored in the memory and executable on the processor, wherein when the processor executes the program, the steps of the elevator control method according to any one of the foregoing embodiments are implemented.

According to a fifth aspect of the present invention, a computer readable storage medium storing a computer program is provided, wherein the program is executed by a processor to implement the steps of the elevator control method according to any one of the foregoing embodiments.

The foregoing features and operations of the present invention will become more apparent from the following description and the accompanying drawings.

### BRIEF DESCRIPTION OF THE DRAWINGS

The following detailed description with reference to the accompanying drawings will make the foregoing and other objectives and advantages of the present invention more complete and clearer, wherein identical or similar elements are denoted by using identical reference numerals.

FIG. 1 is a schematic structural diagram of an elevator control device according to an embodiment of the present invention.

FIG. 2 schematically illustrates evacuation floors in a building to which an elevator system is applied according to an embodiment of the present invention.

FIG. 3 schematically illustrates disaster information, occupant information, and remaining capacities of elevator cars, which are used by an elevator control device, according to an embodiment of the present invention.

FIG. 4 is a schematic flowchart of an elevator control method according to an embodiment of the present invention.

FIG. 5 schematically illustrates a process of evacuating occupants by using an elevator control method according to an embodiment of the present invention.

FIG. 6 schematically illustrates a process of evacuating occupants by using an elevator control method according to another embodiment of the present invention.

### DETAILED DESCRIPTION

The present invention is now described more thoroughly with reference to the accompanying drawings. The drawings show exemplary embodiments of the present invention. However, the present invention can be implemented according to many different forms and should not be construed as being limited by the embodiments illustrated herein. On the contrary, these embodiments are provided to make the present disclosure thorough and complete, and fully convey the idea of the present invention to those skilled in the art. As identical reference numerals denote identical elements or parts in the accompanying drawings, the descriptions thereof will be omitted.

Some block diagrams shown in the accompanying drawings are functional entities, which do not necessarily correspond to physically or logically independent entities. The functional entities can be implemented in a software form, or implemented in one or more hardware modules or integrated circuits, or implemented in different networks and/or processing apparatuses and/or micro control apparatuses.

In the present application, a building may include any type of building, facility, residence, shelter or other place suitable for human activities, and may also include a set of constructions such as buildings and facilities, for example, a set of constructions of a school or town. It should also be noted that, in the present application, “building” is not limited to constructions above the ground, and any underground places suitable for human activities, for example, metro stations, also fall within the scope of the definition of “building” in the present application.

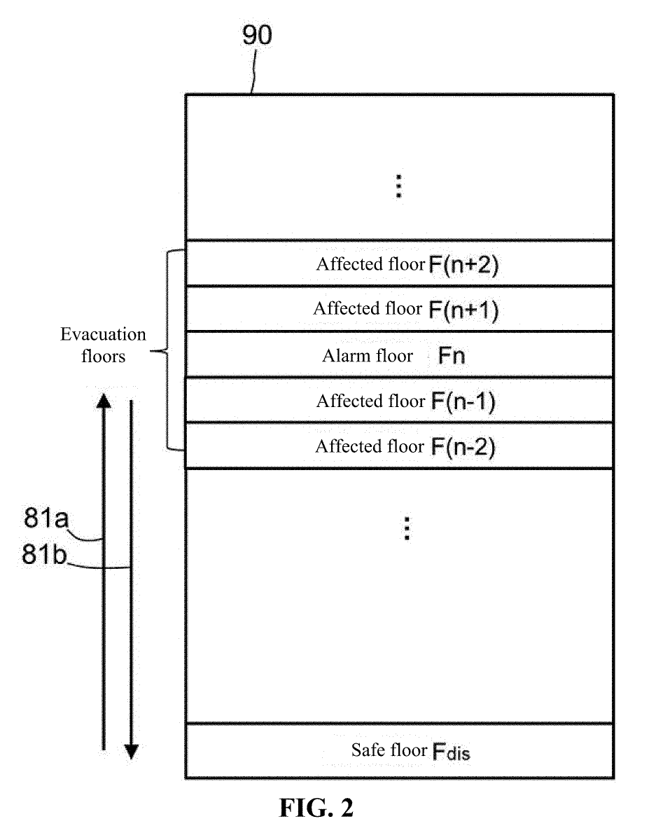

As shown in FIG. 2, the building 90 has a plurality of floors, and may be, for example, a high-rise building. Therefore, once a disaster (for example, fire, earthquake, terrorist attack, etc.) occurs at one or more floors of the building 90, occupants of certain floors need to be evacuated. For example, the occupants need to be evacuated to the safe first floor. An elevator system according to the embodiments of the present invention is configured to evacuate occupants to a safe floor in an evacuation process. The elevator system will be used as part of an evacuation or escape path.

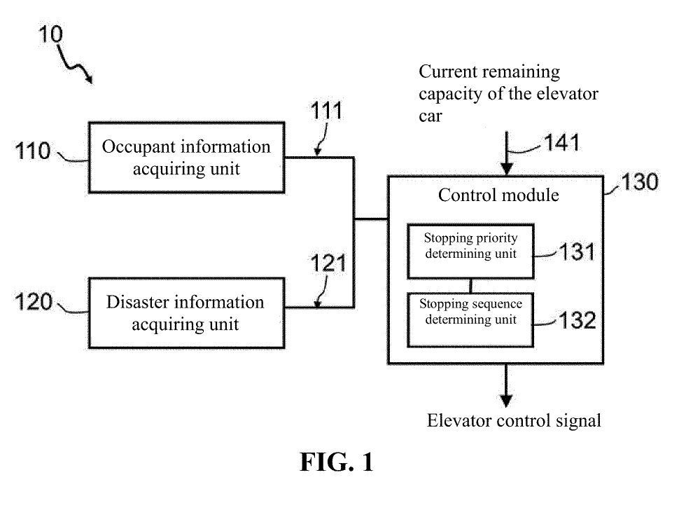

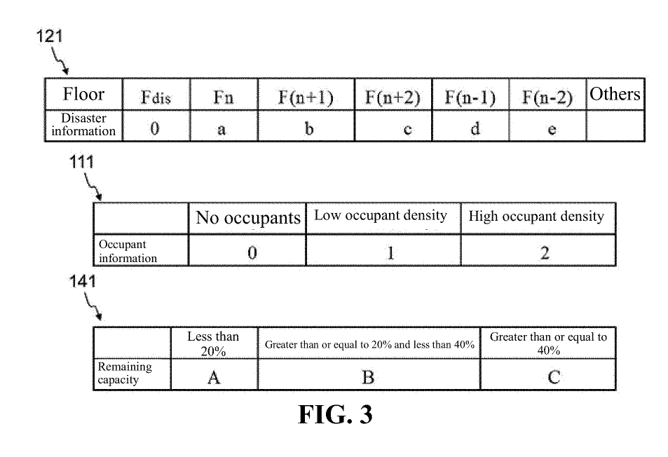

FIG. 1 is a schematic structural diagram of an elevator control device according to an embodiment of the present invention, FIG. 2 schematically illustrates evacuation floors in a building to which an elevator system is applied according to an embodiment of the present invention, and FIG. 3 schematically illustrates disaster information, occupant information, and remaining capacities of elevator cars, which are used by an elevator control device, according to an embodiment of the present invention. An elevator control device 10 according to the embodiments of the present invention is configured to control the elevator system in the building 90, and for example, may be implemented by a controller of the elevator system.

The elevator control device 10 includes a control module 130. The control module 130 may be, for example, implemented by hardware such as a processor or a programmable controller. The control module 130 may be configured to control the travel of one or more elevator cars (not shown in FIG. 1) of the elevator system (for example, upward traveling 81a from a safe floor Fdis to an evacuation floor and downward traveling 81b from the evacuation floor to the safe floor Fdis as shown in FIG. 2).

In an embodiment, the elevator control device 10 may be coupled to an evacuation triggering device distributed at each floor of the building 90. For example, once a disaster such as fire occurs at a particular floor, occupants at the particular floor or other floors will actively try to escape. In this case, an occupant may operate the evacuation triggering device, to send, for example, an alarm signal to the elevator control device 10. After receiving the alarm signal, the elevator control device 10 may determine the floor corresponding to the alarm signal, that is, an alarm floor Fn (as shown in FIG. 2). At the alarm floor Fn, there is currently a safety threat and there are occupants that need to be evacuated. The elevator control device 10 is further configured to determine affected floors affected by the disaster according to the alarm floor Fn, so as to determine a plurality of corresponding evacuation floors. For example, when the alarm floor Fn has been determined, the elevator control device 10 may determine the affected floors according to floors at which there may be a threat to life due to the disaster. For example, floors F(n+2), F(n+1), F(n−1), and F(n−2) are determined to be the affected floors. Therefore, occupants in five floors F(n+2), F(n+1), Fn, F(n−1), and F(n−2) all need to be evacuated, and the five floors are determined to be the evacuation floors.

It should be noted that the specific method for determining evacuation floors is not limited to the above example. For example, the plurality of evacuation floors may not be continuous, and the number of evacuation floors is not limited herein (but is, for example, related to the specific structure of the building, the disaster type, or the like). In addition, the evacuation floor may also dynamically change (for example, as the disaster spreads, or as the number of floors at which corresponding evacuation triggering devices are operated increases).

In an embodiment, the elevator control device 10 includes an occupant information acquiring unit 110. The occupant information acquiring unit 110 is configured to acquire occupant information 111 of a plurality of evacuation floors (for example, F(n+2), F(n+1), Fn, F(n−1), and F(n−2)). The elevator control device 10 further includes a disaster information acquiring unit 120. The disaster information acquiring unit 120 is configured to acquire disaster information of a plurality of evacuation floors (for example, F(n+2), F(n+1), Fn, F(n−1), and F(n−2)). For example, the occupant information acquiring unit 110 may be implemented by using an occupant information capturing component and an occupant information analyzing component (not shown). The occupant information capturing component may be, for example, implemented by using various sensors (for example, RGB-D sensors) or a combination thereof. The occupant information capturing component is installed at a corresponding position on at least one of the plurality of evacuation floors and configured to capture image information of an area corresponding to the position. The specific type of the occupant information capturing component is not limited herein. The occupant information analyzing component is configured to analyze image information captured in real time by one or more occupant information capturing components to acquire the occupant information 111 of the corresponding evacuation floor. Various types of image processing may be performed on the captured image information, so as to obtain the occupant information 111 of each evacuation floor as accurately as possible. The specific method for image processing is not limited herein. It is to be understood that occupant information 111 output from the occupant information acquiring unit 110 and corresponding to a particular evacuation floor or a particular region of the particular evacuation floor will dynamically change as the information captured by the sensors changes.

In an embodiment, the occupant information 111 may be occupant information of a particular area of an evacuation floor, for example, occupant information of a landing area of the evacuation floor. The occupant information 111 may include occupant quantity information. Based on the occupant quantity information, the quantity of occupants that need to be evacuated can be approximately determined. Or the occupant information 111 may further include at least one of the following types of information: occupant distribution information, occupant flow information, and occupant feature information.

The occupant distribution information includes, for example, but is not limited to, occupant position distribution and/or occupant density distribution information. The occupant flow information includes, for example, but is not limited to, occupant flow direction, occupant flow movement speed, occupant flow quantity, and/or occupant flow crowding information. The occupant feature information includes, for example, but is not limited to, age characteristic, body shape (for example, reflecting whether an occupant is a disabled person), facial expression, and/or gender information. It is to be understood that based on the occupant distribution information, the occupant flow information, and/or the occupant feature information, the quantity of occupants that need to be evacuated at the current moment or within a particular time period in the future can be more accurately determined or predicted.

In an embodiment, the disaster information acquiring unit 120 may also include a disaster information capturing component and a disaster information analyzing component. The disaster information capturing component may be specifically implemented by various sensors or a combination thereof installed onsite at the evacuation floor. For example, it may be a smoke sensor, a temperature sensor, and/or a visual sensor. Specifically, the visual sensor may be used in combination with an image sensor of the occupant information capturing component. The disaster information analyzing component analyzes the information currently captured by the disaster information capturing component, so as to obtain in real time the disaster information 121 of the corresponding evacuation floor or a corresponding area of the corresponding evacuation floor. It is to be understood that the disaster information 121 output by the disaster information acquiring unit 120 and corresponding to a particular evacuation floor or a particular area of the particular evacuation floor will dynamically change as the information captured by the sensors changes.

In an embodiment, the disaster information 121 includes, but is not limited to, at least one of the following types of information: disaster type information, threat position information, disaster spreading information, and threat development trend information. Disaster type information may represent the type of the disaster that is occurring, for example, fire, earthquake, or terrorist attack, etc. Threat position information may reflect a position or area that threatens the lives of occupants at the corresponding evacuation floor, and for example, may reflect a fire position point or the like. Disaster spreading information may represent the dynamic change in the disaster. For example, it may reflect the spread of smoke or the area through which a fire has spread. Threat position information may also change as disaster spreading information changes. Threat development trend information may represent a dynamic change in danger levels or threat levels, or the dynamic development of the position or area in which the lives of occupants are threatened. It is to be understood that threat position information, disaster spreading information, and threat development trend information in particular may dynamically reflect in real time the change in the disaster status at each evacuation floor, and thus reflect the change in the degree to which the occupants' lives are threatened. They may also dynamically reflect in real time the change in the disaster status of a plurality of areas of an evacuation floor, and thus reflect the change in the degree to which the occupants' lives are threatened.

It should be noted that the change within a particular period of time in the future, for example, of at least one part of the occupant information 111 and the disaster information 121 in the above example of the present invention may be predicted by a method such as deep learning, for example. The occupant information acquiring unit 110 and the disaster information acquiring unit 120 may be independently disposed as shown in FIG. 1, or they may be integrated. The occupant information acquiring unit 110 and the disaster information acquiring unit 120 may also acquire required occupant information 111 and disaster information 121 from, for example, a building management system or smart evacuation system disposed in the building.

Still referring to FIG. 1, the occupant information 111 output by the occupant information acquiring unit 110 and the disaster information 121 output by the disaster information acquiring unit 120 are both sent to the control module 130. Specifically, the control module 130 may include a corresponding receiving unit to receive in real time the occupant information 111 and the disaster information 121. The occupant information 111 and the disaster information 121 are readable by the control module 130. In the present application, changes in the occupant information 111 and the disaster information 121 of the plurality of evacuation floors are comprehensively taken into consideration in the control of the elevator system in the evacuation process. The control module 130 may be configured to control, according to the occupant information and the disaster information of the plurality of evacuation floors, stopping of an elevator car of the elevator system at at least one of the plurality of evacuation floors. For example, stopping of the elevator car of the elevator system at at least one of the plurality of evacuation floors is controlled according to the real-time occupant information and disaster information of the plurality of evacuation floors. In this way, unlike existing elevator systems where an elevator car in evacuation mode travels back and forth in shuttle-bus mode between a particular evacuation floor and a safe floor without intermediate stopping, the present invention can effectively increase evacuation efficiency and make the evacuation process more scientifically sound.

It should be noted that stopping corresponding to the evacuation floor may include initial stopping and intermediate stopping. Initial stopping refers to a stopping operation that the elevator car running in evacuation mode performs upon first arriving at a particular evacuation floor, for example, traveling upward 81a from the safe floor Fdis to a particular evacuation floor and stopping at the particular evacuation floor. Initial stopping can allow to-be-evacuated occupants at the evacuation floor to be basically the first to enter the elevator car. Correspondingly, in the present application, the evacuation floor for initial stopping is defined as the first evacuation floor in the plurality of evacuation floors. Intermediate stopping refers to a stopping operation that the elevator car running in evacuation mode makes upon traveling to one or more other evacuation floors after initial stopping at a particular evacuation floor, for example, stopping at an intermediate evacuation floor in the process of traveling from the first evacuation floor for initial stopping to the safe floor Fdis. Intermediate stopping can allow to-be-evacuated occupants at the evacuation floor to enter the elevator car later. Correspondingly, in the present application, the evacuation floor for intermediate stopping is defined as a second evacuation floor in the plurality of evacuation floors.

It should be understood that the evacuation floor corresponding to the first evacuation floor for initial stopping may dynamically change according to the current occupant information 111 and disaster information 121 of the plurality of evacuation floors, and the evacuation floor corresponding to the second evacuation floor for intermediate stopping may also dynamically change according to the current occupant information 111 and disaster information 121 of the plurality of evacuation floors. The second evacuation floor may be located above or below the first evacuation floor.

In an embodiment, when it may be determined, according to real-time disaster information such as disaster spreading information and/or threat development trend information of a particular evacuation floor, for example, that a hoistway corresponding to the evacuation floor is no longer safe—that is, when the control module 130 determines that the evacuation floor cannot be safely stopped at—the elevator car is prohibited from stopping at the evacuation floor (neither initial stopping nor intermediate stopping), even if the evacuation floor is an alarm floor Fn corresponding to an alarm signal sent by an occupant pressing an evacuation triggering device. In this way, the safety of the elevator car when it stops at an evacuation floor and safety during running can be substantially ensured.

When the control module 130 according to the embodiments of the present invention is configured to control the elevator system in evacuation mode, its stopping strategy is not fixed, unlike shuttle-bus mode in the prior art. In an embodiment, the control module 130 is further configured to dynamically adjust a stopping strategy for the elevator car corresponding to at least one of the plurality of evacuation floors according to real-time changes in the occupant information 111 of the plurality of evacuation floors and the disaster information 121 of the plurality of evacuation floors. For example, the evacuation floor corresponding to the first evacuation floor for initial stopping may dynamically change as the occupant information 111 and the disaster information 121 of the plurality of evacuation floors change, and the evacuation floor corresponding to the second evacuation floor for intermediate stopping may also dynamically change as the occupant information 111 and the disaster information 121 of the plurality of evacuation floors change. Therefore, the stopping strategy for the elevator car can better conform to the current disaster developments and occupant evacuation requirements, facilitating the safe and reliable evacuation of occupants at the plurality of evacuation floors. The specific manner of dynamic change will be described in the following example.

In an embodiment, the control module 130 is configured to control the travel of the elevator car from a first evacuation floor for initial stopping to a safe floor, and the control module 130 is further configured to control, according to the current occupant information 111 and disaster information 121 of the plurality of evacuation floors, whether the elevator car performs intermediate stopping at one or more second evacuation floors other than the first evacuation floor among the plurality of evacuation floors. In an example, the elevator car still has remaining load capacity after stopping at the first evacuation floor (for example, Fn), and when the elevator car travels downward toward the safe floor Fdis, it may be found according to the occupant information 111 of the evacuation floor F(n−2) that an elderly person with limited mobility is waiting at the landing area to take the elevator. In this case, the control module 130 may send a control instruction for making an intermediate stop at the evacuation floor F(n−2), so that the elevator car intermediately stops at the second evacuation floor F(n−2) and then continues to travel downward 81b toward the safe floor Fdis. In another example, the elevator car still has remaining load capacity after initially stopping at the first evacuation floor (for example, Fn), and it is found according to changes in the disaster information 121 of the evacuation floor that the fire has spread to the evacuation floor F(n+2) and the threat level is high. In this case, the control module 130 may send a control instruction for making an intermediate stop at the evacuation floor F(n+2), so that the elevator car travels upward to the second evacuation floor F(n+2), intermediately stops at the second evacuation floor, and then continues to travel downward 81b toward the safe floor Fdis. Therefore, it should be understood that intermediate stopping can greatly increase the efficiency of transporting occupants in the evacuation process and can also overcome the problem in the prior art that the elevator car in evacuation mode cannot perform intermediate stopping.

In an embodiment, the control of stopping at at least one of the plurality of evacuation floors by the control module 130 not only considers the occupant information 111 and the disaster information 121 of the plurality of evacuation floors, but also considers the current remaining capacity 141 of the elevator car (as shown in FIG. 3). In other words, the control module 130 further controls, according to the current remaining capacity 141 of the elevator car, intermediate stopping of the elevator car at least one of the plurality of evacuation floors.

The remaining capacity 141 may be calculated in real time according to the rated load of the elevator car and the current load of the elevator car, and for example, may be expressed as a percentage of the rated load of the elevator car (as shown in FIG. 3).

In an embodiment, when the current remaining capacity 141 of the elevator car during initial stopping or intermediate stopping is greater than or equal to a first predetermined value, the control module 130 controls the elevator car to continue stopping for a first predetermined time period. The first predetermined value may be 10%-30% of the rated load of the elevator car (for example, 20%), and the first predetermined time period may be 30S-90S (for example, 60S).

For example, referring to FIG. 3, if the elevator car performs initial stopping at a particular first evacuation floor/second evacuation floor (after stopping for a predetermined time), and the current remaining capacity 141 of the elevator car is greater than or equal to 20% (cases corresponding to B or C as shown in FIG. 3), it indicates that the elevator car can carry more passengers. To increase evacuation efficiency, the control module 130 may control the elevator car to continue stopping for 60S. After stopping for 60S, the control module 130 controls the elevator car to continue to travel regardless of whether the current remaining capacity 141 is greater than or equal to 20%, thereby avoiding an unduly long waiting time which may affect evacuation efficiency.

In an embodiment, the control module 130 is further configured to control, according to the current remaining capacity 141 of the elevator car, whether the elevator car performs intermediate stopping at one or more second evacuation floors other than the first evacuation floor among the plurality of evacuation floors. For example, the control module 130 is further configured to: when the current remaining capacity 141 of the elevator car after initial stopping is greater than or equal to a second predetermined value, control whether the elevator car performs intermediate stopping at the second evacuation floor at least based on occupant information 111 and the disaster information 121 corresponding to the second evacuation floor. The second predetermined value may be 30%-50% of the rated load of the elevator car (for example, 40%).

For example, referring to FIG. 3, after the elevator car performs initial stopping at a particular first evacuation floor Fn, if the current remaining capacity 141 of the elevator car is greater than or equal to 40% (a case corresponding to C in as shown FIG. 3), it indicates that the elevator car still has a large carrying capacity. To further increase evacuation efficiency, if the control module 130 finds according to the occupant information 111 (for example, the occupant quantity information and the occupant feature information) and the disaster information 121 (such as the disaster spreading information) of the evacuation floor that the disaster is severe at another evacuation floor (for example, F(n+1)) above or below the first evacuation floor Fn and there are children needing to be quickly evacuated, the control module 130 may send a corresponding control command to control the elevator car to perform intermediate stopping at the evacuation floor F(n+1) (that is, the second evacuation floor), and then send an instruction for traveling toward the safe floor Fdis. In this way, the transport capacity of the elevator car can be fully utilized, which helps increase evacuation efficiency.

Still referring to FIG. 1, in an embodiment, the control module 130 includes a stopping priority determining unit 131. The stopping priority determining unit 131 is configured to determine, based on received real-time occupant information 111 and disaster information 121 corresponding to the plurality of evacuation floors, priorities of the plurality of evacuation floors as the first evacuation floor for initial stopping. It is to be understood that the priority reflects the evacuation priority of each evacuation floor. For example, referring to FIG. 3, the disaster information 121 shows the respective disaster information of the evacuation floors Fn, F(n+1), F(n+2), F(n−1), and F(n−2) at a particular moment, respectively represented by a, b, c, d, and e, and the threat levels corresponding to the disaster information a, b, c, d, and e gradually decrease. Therefore, without considering the occupant information 111, the priorities of the evacuation floors Fn, F(n+1), F(n+2), F(n−1), and F(n−2) as the first evacuation floor also gradually decrease correspondingly. In the occupant information 111, 0, 1, and 2 are respectively used to represent no occupants, low occupant density (indicating, for example, a small quantity of occupants in the landing area), and high occupant density (indicating, for example, a large quantity of occupants in the landing area). In the present application, the respective occupant quantity information of the evacuation floors Fn, F(n+1), F(n+2), F(n−1), and F(n−2) also needs to be considered. For example, if the disaster information 121 of a particular evacuation floor corresponds to a high threat level and a large quantity of occupants, the evacuation floor has a high priority for being selected as the first evacuation floor for initial stopping. On the contrary, if the disaster information 121 of a particular evacuation floor corresponds to a low threat level and a small quantity of occupants, the evacuation floor has a low priority for being selected as the first evacuation floor for initial stopping. Of course, if the occupant information 111 of a particular evacuation floor is 0 (that is, no occupants), the priority of the evacuation floor may be the lowest even if the disaster information 121 of the evacuation floor corresponds to a high threat level.

It is to be understood that provided that the basic principle of calculating the priority of each evacuation floor as the first evacuation floor for initial stopping based on the disaster information 121 and the occupant information 111 of the plurality of evacuation floors is already determined, various specific calculation methods may be designed, such as setting a weight for each type of information during the calculation of the priority. In addition, each time the elevator car runs to the safe floor Fdis, the priority of each evacuation floor as the first evacuation floor for initial stopping may be re-determined, so that each time the elevator car travels upward from the safe floor Fdis, the first evacuation floor at which the elevator car is to perform initial stopping can be dynamically determined based on the priority information. In other words, the evacuation floor corresponding to the first evacuation floor may dynamically change.

In an embodiment, the control module 130 further includes a stopping sequence determining unit 132. The stopping sequence determining unit 132 is configured to determine a sequence of initial stops based on the priorities for initial stopping that is output by the stopping priority determining unit 131. For example, if the priorities of the evacuation floors Fn, F(n+1), F(n+2), F(n−1), and F(n−2) decrease in sequence, the elevator car performs initial stopping at the evacuation floors Fn, F(n+1), F(n+2), F(n−1), and F(n−2) in sequence. To be specific, for example, after initial stopping at the evacuation floor Fn is complete, initial stopping at the evacuation floor F(n+1) is performed. The rest can be deduced by analogy. It is to be understood that the sequence of initial stopping will change as the priorities for initial stopping output by the stopping priority determining unit 131 dynamically change.

In an embodiment, still referring to FIG. 1, the stopping priority determining unit 131 is configured to respectively determine, based on real-time occupant information and disaster information corresponding to a plurality of second evacuation floors, priorities of the second evacuation floors for intermediate stopping. For example, when intermediate stopping of the elevator car is permitted, the stopping priority determining unit 131 calculates in real time, after the elevator car completes initial stopping at the evacuation floor Fn, priorities of a plurality of floors F(n+1), F(n+2), F(n−1), and F(n−2) that may serve as the second evacuation floor for intermediate stopping. With reference to the disaster information 121 and the occupant information 111 shown in FIG. 3, if the occupant information 111 of the floor F(n+1) is high occupant density 2, the priority of the floor F(n+1) for intermediate stopping is set as the highest; if the occupant information of the floor F(n+1) is no occupants 0, the priority of the floor F(n+1) for intermediate stopping is set as low.

Further, the stopping sequence determining unit 132 is further configured to determine, based on the priorities of the plurality of second evacuation floors for intermediate stopping, a second evacuation floor at which the elevator car needs to intermediately stop in the current process of traveling from the first evacuation floor for initial stopping (for example, Fn) to the safe floor Fdis (where the traveling process may be one-way downward traveling, or it may be a process of first upward and then downward traveling), and/or to determine, based on the priorities of the plurality of second evacuation floors for intermediate stopping, a sequence for intermediate stopping. As exemplified above, when the priority of the floor F(n+1) for intermediate stopping is set as the highest, the stopping sequence determining unit 132 determines based on the priority information that among the plurality of floors F(n+1), F(n+2), F(n−1), and F(n−2), the floor F(n+1) is the second evacuation floor at which intermediate stopping needs to be performed. The control module 130 controls the elevator car to run upward from the first evacuation floor Fn to the second evacuation floor F(n+1), until the remaining capacity 141 of the elevator car is, for example, less than 20%, and then it controls the elevator car to travel downward to the safe floor Fdis. If the current remaining capacity 141 of the elevator car is still greater than or equal to 40% after the intermediate stop at the second evacuation floor F(n+1), the stopping sequence determining unit 132 may further determine according to the calculated priorities, the next second evacuation floor at which intermediate stopping needs to be performed, for example, F(n+2) (when the occupant information 111 of F(n+2) is high occupant density information 2).

Based on the above control principle, the control module 130 as shown in FIG. 1 may output corresponding elevator control information, particularly a corresponding target floor instruction, so as to determine the floor for stopping.

It is to be understood that when occupants at a plurality of evacuation floors need to be evacuated in the elevator system controlled based on the elevator control device 10, the entire evacuation process of the plurality of evacuation floors will become more efficient. For example, provided that the total quantity of occupants at the plurality of evacuation floors is fixed, the total evacuation time corresponding to the total quantity of occupants can be greatly reduced, especially in high-rise buildings. In addition, after real-time disaster information is considered, the entire evacuation process can further be made safer and more reliable by adjusting the stopping strategy for initial stopping and/or intermediate stopping, for example. As an example, occupants subject to a more serious threat are preferentially transported to the safe floor. Therefore, the entire evacuation process becomes more scientific, sound, and efficient.

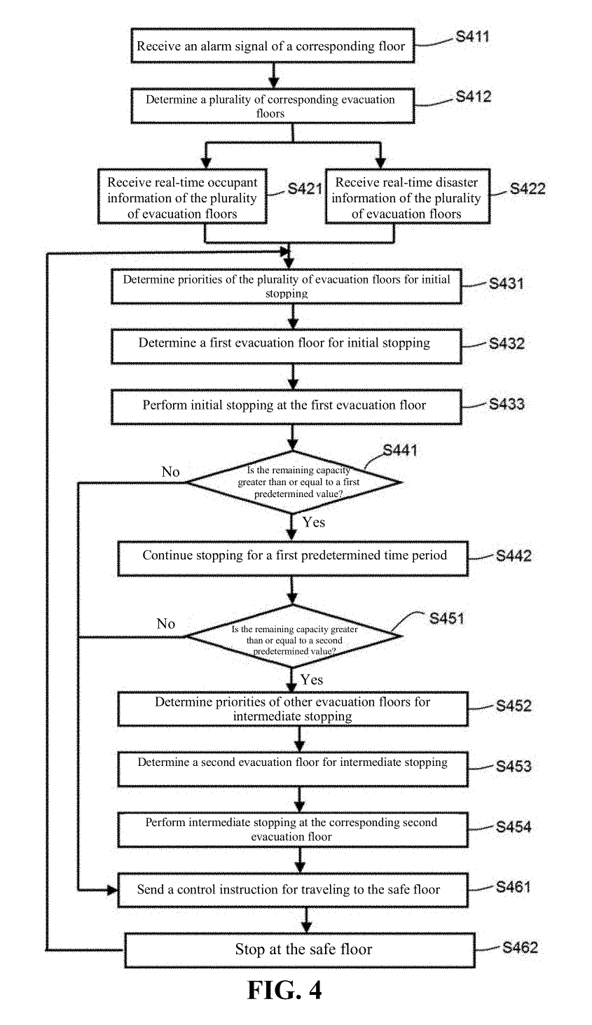

FIG. 4 is a schematic flowchart of an elevator control method according to an embodiment of the present invention. The elevator control method according to the embodiments of the present invention are described in detail below through examples and with reference to FIG. 2 to FIG. 4. It should be understood that the elevator control method is performed in evacuation mode. The evacuation mode may be triggered in a certain manner, and may be ended, for example, manually (for example, when the evacuation process ends, the disaster alarm is canceled, or the evacuation of occupants through elevators is prohibited).

First, in step S411, an alarm signal from a corresponding floor is received. For example, the elevator control device 10 of the elevator system may receive an alarm signal from one or more floors. The alarm signal may be generated by occupants at the one or more floors by operating the evacuation triggering device.

Further, in step S412, a plurality of corresponding evacuation floors is determined. In this step, evacuation floors at which occupants need to be evacuated may be determined based on information such as the floor where the disaster occurs, the floor where the alarm signal is generated, and the floors that may be affected by the disaster. Specifically, for example, as shown in FIG. 2, five floors F(n+2), F(n+1), Fn, F(n−1), and F(n−2) are determined to be the evacuation floors.

In step S421, real-time occupant information 111 of the plurality of evacuation floors is received. In this step, the control module 130 receives real-time occupant information 111 of the plurality of evacuation floors, for example, the occupant information 111 of each of the five evacuation floors F(n+2), F(n+1), Fn, F(n−1), and F(n−2). The occupant information 111 may be acquired by a capturing component such as an image sensor and the occupant information analyzing component. The specific acquisition method of the occupant information 111 is not limited herein. The occupant information may be occupant information of a particular area of an evacuation floor, for example, occupant information of a landing area of the evacuation floor. The occupant information may include occupant quantity information. Based on the occupant quantity information, the quantity of occupants that need to be evacuated can be approximately determined. Or the occupant information may further include at least one of the following types of information: occupant distribution information, occupant flow information, and occupant feature information.

At the same time, in step S422, real-time disaster information 121 of the plurality of evacuation floors is received. In this step, the control module 130 also receives the real-time disaster information 121 of the plurality of evacuation floors. For example, FIG. 3 shows disaster information 121 of the five evacuation floors F(n+2), F(n+1), Fn, F(n−1), and F(n−2) at a particular moment. The specific acquisition method for the disaster information 121 is also not limited herein. The disaster information 121 includes, but is not limited to, at least one of the following types of information: disaster type information, threat position information, disaster spreading information, and threat development trend information.

Further, in step S431, priorities of the plurality of evacuation floors for initial stopping are determined. In this step, based on the currently received occupant information 111 and disaster information 121 of the plurality of evacuation floors, a basic calculation manner is determined according to predetermined priorities, and the priorities of the plurality of evacuation floors as a first evacuation floor for initial stopping is determined, that is, the priorities of the plurality of evacuation floors for initial stopping is determined. It should be noted that as the currently received occupant information 111 and disaster information 121 of the plurality of evacuation floors dynamically change, the priorities of the plurality of evacuation floors for initial stopping may also change correspondingly.

It is to be understood that the priority reflects the evacuation priority of each evacuation floor. For example, referring to FIG. 3, the disaster information 121 shows the respective disaster information of the evacuation floors Fn, F(n+1), F(n+2), F(n−1), and F(n−2), respectively represented by a, b, c, d, and e, and the threat levels corresponding to the disaster information a, b, c, d, and e gradually decrease. Therefore, without considering the occupant information 111, the priorities of the evacuation floors Fn, F(n+1), F(n+2), F(n−1), and F(n−2) as the first evacuation floor also gradually decrease correspondingly. In the occupant information 111, 0, 1, and 2 are respectively used to represent no occupants, low occupant density (indicating, for example, a small quantity of occupants in the landing area), and high occupant density (indicating, for example, a large quantity of occupants in the landing area). In the present application, the respective occupant quantity information of the evacuation floors Fn, F(n+1), F(n+2), F(n−1), and F(n−2) also needs to be considered. For example, if the disaster information 121 of a particular evacuation floor corresponds to a high threat level and a large quantity of occupants, the evacuation floor has a high priority for being selected as the first evacuation floor for initial stopping. On the contrary, if the disaster information 121 of a particular evacuation floor corresponds to a low threat level and a small quantity of occupants, the evacuation floor has a low priority for being selected as the first evacuation floor for initial stopping. Obviously, if the occupant information 111 of a particular evacuation floor is 0 (that is, no occupants), the priority of the evacuation floor may be the lowest even if the disaster information 121 of the evacuation floor corresponds to a high threat level.

It is to be understood that provided that the basic principle of calculating the priority of each evacuation floor as the first evacuation floor for initial stopping based on the disaster information 121 and the occupant information 111 of the plurality of evacuation floors is already determined, various specific calculation methods may be designed, such as setting a weight for each type of information during the calculation of the priority.

Further, in step S432, the first evacuation floor for initial stopping is determined. In this step, based on the priority information determined in step S431, the current first evacuation floor for initial stopping is determined from the plurality of evacuation floors. For example, based on the priorities of initial stopping, a sequence of initial stopping can be determined, and then, for example, the evacuation floor with the highest priority can be selected as the current first evacuation floor for initial stopping.

Further, in step S433, initial stopping is performed at the first evacuation floor. In this step, for example, based on the first evacuation floor for initial stopping (such as Fn) determined in step S432, a corresponding target floor control command is generated, to control the elevator car to travel upward to the first evacuation floor, and initial stopping is performed at the first evacuation floor, so that the occupants at the first evacuation floor can enter the elevator car.

In an embodiment, in step S441, after the elevator car has performed initial stopping for a predetermined period of time, it is determined whether the remaining capacity 141 of the elevator car is greater than or equal to a first predetermined value. In this step, for example, the remaining capacity 141 of the elevator car is determined based on the load of the elevator car after stopping for a predetermined period of time (where the load may be detected in real time by a sensor) as well as the known rated load, and then it is determined whether the remaining capacity 141 is greater than or equal to the first predetermined value. The first predetermined value may be 10%-30% of the rated load of the elevator car (for example, 20% as shown in FIG. 3).

If the determination in step S441 is yes, it indicates that the elevator car can carry more occupants, and the method proceeds to step S442, in which the elevator car continues stopping for the first predetermined time period (for example, 60S) to wait for more occupants.

If the determination in step S441 is no, it indicates that the elevator car basically cannot carry more occupants, and the method proceeds to step S461, in which a control command for traveling to the safe floor Fdis is sent, and the elevator car will travel from the first evacuation floor for initial stopping directly to the safe floor Fdis. In this case, intermediate stopping at other evacuation floors may be disregarded.

Further, in step S451, it is determined whether the remaining capacity 141 is greater than or equal to a second predetermined value. The second predetermined value is set at greater than the first predetermined value, and the second predetermined value may be 30%-50% of the rated load of the elevator car (for example, 40% as shown in FIG. 3).

If the determination in step S451 is no, it indicates that the elevator car is basically unsuitable for intermediate stopping to take more occupants, and the method proceeds to step S461, in which a control command for traveling to the safe floor Fdis is sent, and the elevator car will travel from the first evacuation floor for initial stopping directly to the safe floor Fdis. In this case, intermediate stopping at other evacuation floors may be disregarded.

If the determination in step S451 is yes, it indicates that the elevator car still has a large carrying capacity. To further increase evacuation efficiency, intermediate stopping may be further performed to take the occupants at other evacuation floors. Therefore, in an embodiment, the method proceeds to step S452, in which the priorities of other evacuation floors for intermediate stopping are determined. Specifically, based on the occupant information and the disaster information corresponding to the other evacuation floors, the priorities of the plurality of other evacuation floors for intermediate stopping are determined respectively. For example, after the elevator car completes initial stopping at the evacuation floor Fn, the priorities of a plurality of floors F(n+1), F(n+2), F(n−1), and F(n−2) that may serve as a second evacuation floor for intermediate stopping are calculated in real time. With reference to the disaster information 121 and the occupant information 111 corresponding to the other evacuation floors shown in FIG. 3, if the occupant information 111 of the floor F(n+1) is high occupant density 2, the priority of the floor F(n+1) for intermediate stopping is set as the highest; if the occupant information of the floor F(n+1) is no occupants 0, the priority of the floor F(n+1) for intermediate stopping is set as low.

Further, in step S453, a second evacuation floor for intermediate stopping is determined. In this step, based on the priorities of the plurality of other evacuation floors for intermediate stopping, a second evacuation floor at which the elevator car needs to intermediately stop in the current process of traveling from the first evacuation floor for initial stopping (for example, Fn) to the safe floor Fdis (where the traveling process may be one-way downward traveling, or it may be a process of first upward and then downward traveling) is determined. If there is one second evacuation floor at which the elevator car needs to intermediately stop, it is determined to be the second evacuation floor for intermediate stopping; if there is a plurality of second evacuation floors at which the elevator car needs to intermediately stop, a sequence for intermediate stopping is determined based on the priorities of the plurality of second evacuation floors for intermediate stopping, to determine a current second evacuation floor for intermediate stopping.

Further, in step S454, intermediate stopping is performed at the corresponding second evacuation floor. In this step, based on the determined second evacuation floor for intermediate stopping, a corresponding target floor command is sent to the elevator system, to control the elevator car to perform intermediate stopping at the second evacuation floor, so that the occupants at the second evacuation floor may enter the elevator car, thereby greatly increasing evacuation efficiency.

After the intermediate stop, step S461 is performed to send a control instruction for controlling the elevator car to travel to the safe floor. It is to be understood that in a process of traveling from the first evacuation floor for initial stopping back to the safe floor, steps S451 to S454 may be repeatedly performed if the remaining capacity of the elevator car meets the predetermined condition according to the actual situation, so that intermediate stopping can be performed sequentially at different second evacuation floors according to the priorities for intermediate stopping. Thus, more occupants can be evacuated from more floors through one round trip of the elevator car, thereby further increasing evacuation efficiency.

Further, in step S462, the elevator car stops at the safe floor for the occupants to leave the building 90. Thus, the elevator car completes one round trip. In an embodiment, the process may be repeated by repeatedly performing step S431 to control round trips of the elevator car. As such, the stopping strategy corresponding to initial stopping and/or intermediate stopping in each round trip can be dynamically changed according to the currently received occupant information 111 and disaster information, making the stopping strategy more scientific and sound.

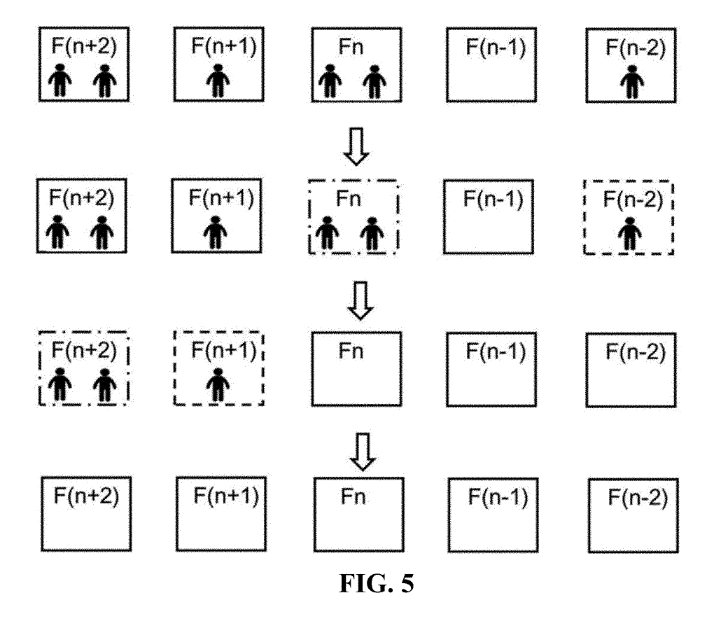

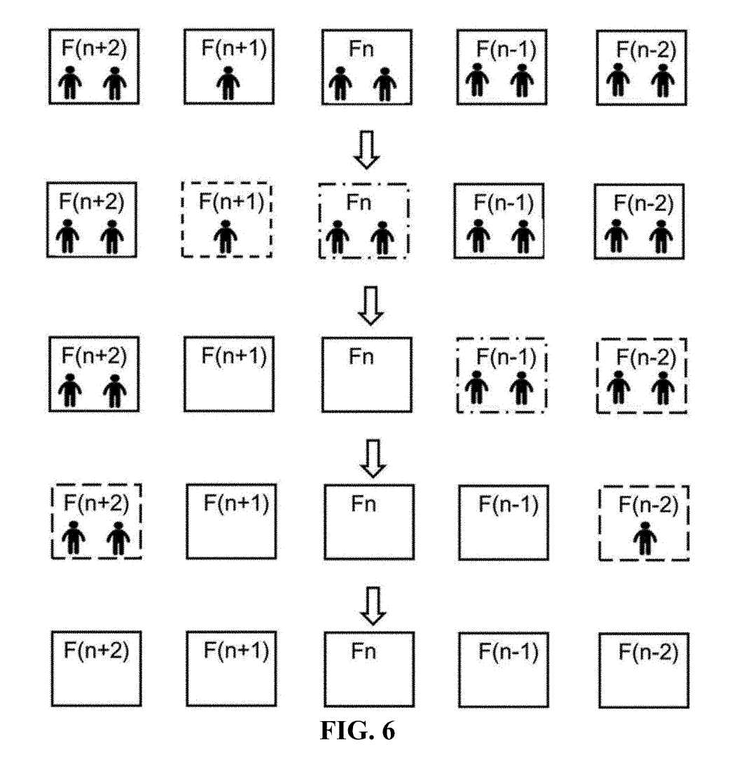

FIG. 5 and FIG. 6 below specifically schematically illustrate a process of evacuating occupants by using an elevator control method according to an embodiment of the present invention. The advantages of the elevator control device and method according to the embodiments of the present invention in efficient and reliable evacuation can be well understood in connection with the evacuation processes schematically illustrated in FIG. 5 and FIG. 6.

As shown in FIG. 5 and FIG. 6, the plurality of evacuation floors F(n+1), F(n+2), Fn, F(n−1), and F(n−2) at which occupants need to be evacuated as shown in FIG. 2 are similarly taken as an example. Images of human figures for the respective floors reflect the occupant information. A larger number of human figure images indicates that there are a larger number of occupants to be evacuated, and a small number of human figure images indicates that there are a small number of occupants to be evacuated. An evacuation floor corresponding to a dot-dash line frame indicates that it has been determined by the elevator control device 10 to be the current first evacuation floor for initial stopping, and an evacuation floor corresponding to a dashed line frame indicates that it has been determined by the elevator control device 10 to be the current second evacuation floor for intermediate stopping.

In the evacuation process as shown in FIG. 5, it is assumed that: the alarm information comes from floor Fn; evacuation floor F(n−1) has no occupants requiring evacuation, so the elevator car does not need to land at evacuation floor F(n−1); and there are more occupants at evacuation floors F(n+2) and Fn than at evacuation floors F(n+1) and F(n−2).

First, according to the stopping strategy determining principle in the above example of the present invention, evacuation floor Fn is first determined to be the first evacuation floor for initial stopping. After the occupants at evacuation floor Fn enter the elevator car, the elevator car still has a large remaining capacity. Then, evacuation floor F(n−2) is determined to be the second evacuation floor for intermediate stopping according to the calculated priorities of intermediate stopping. The elevator car travels from evacuation floor Fn to evacuation floor F(n−2) and performs intermediate stopping. The occupants at evacuation floor F(n−2) enter the elevator car, and then the elevator car continues to travel to the safe floor Fdis. Therefore, the elevator car can safely transport the occupants from evacuation floor Fn and evacuation floor F(n−2) that need to be evacuated preferentially to the safe floor through one round trip.

Further, based on the occupant information 111 and the disaster information 121 of the current evacuation floors, especially by comprehensively comparing the occupant information 111 and the disaster information 121 of the remaining evacuation floors F(n+1) and F(n+2) having occupants awaiting evacuation, the priorities of evacuation floors F(n+1) and F(n+2) for initial stopping are calculated. Evacuation floor F(n+2) has a high priority for initial stopping and is determined to be the first evacuation floor for initial stopping. After the occupants at evacuation floor F(n+2) enter the elevator car during initial stopping, the elevator car still has a large remaining capacity. Therefore, the elevator car further perform intermediate stopping at evacuation floor F(n+1). After the occupants at evacuation floor F(n+1) enter the elevator car, the elevator car continues to travel to the safe floor Fdis. Therefore, the elevator car can safely transport the occupants on evacuation floors F(n+2) and F(n+1) to the safe floor through one round trip.

The efficiency of the entire evacuation process for the plurality of evacuation floors in FIG. 5 is significantly improved, and the evacuation process is safe and reliable. It is to be understood that if the evacuation method in the prior art were used, at least four round trips of the elevator car would be needed.

In the evacuation process as shown in FIG. 6, it is assumed that the alarm information comes from floor Fn, all evacuation floors have occupants who need to be evacuated, and there are relatively fewer occupants at evacuation floor F(n−1).

First, according to the stopping strategy determining principle in the above example of the present invention, evacuation floor Fn is first determined to be the first evacuation floor for initial stopping. After the occupants at evacuation floor Fn enter the elevator car, the elevator car still has a large remaining capacity. Then, evacuation floor F(n+1) is determined to be the second evacuation floor for intermediate stopping according to the calculated priorities of intermediate stopping. The elevator car travels from evacuation floor Fn to evacuation floor F(n+1) and performs intermediate stopping. After the occupants at evacuation floor F(n+1) enter the elevator car, the elevator car continues to travel downward to the safe floor Fdis.

Further, based on the occupant information 111 and the disaster information 121 of the current evacuation floors, especially by comprehensively comparing the occupant information 111 and the disaster information 121 of the remaining evacuation floors F(n−1), F(n−2), and F(n+2) having occupants awaiting evacuation, the priorities of evacuation floors F(n−1), F(n−2), and F(n+2) for initial stopping are calculated. Evacuation floor F(n−1) has a high priority for initial stopping and is determined to be the first evacuation floor for initial stopping. After the occupants at evacuation floor F(n−1) enter the elevator car during initial stopping, the elevator car still has a large remaining capacity. Further, according to the current priorities of evacuation floors F(n−2) and F(n+2) for intermediate stopping, evacuation floor F(n−2) is determined to be the second evacuation floor for intermediate stopping. The elevator car travels from evacuation floor F(n−1) downward to evacuation floor F(n−2) and performs intermediate stopping. After some occupants at evacuation floor F(n+1) enter the elevator car, the elevator car continues to travel downward to the safe floor Fdis.

Further, based on the occupant information 111 and the disaster information 121 of the current evacuation floors, especially by comprehensively comparing the occupant information 111 and the disaster information 121 of the remaining evacuation floors F(n−2) and F(n+2) having occupants awaiting evacuation, the priorities of evacuation floors F(n+2), and F(n−2) for initial stopping are calculated. Evacuation floor F(n+2) has a high priority for initial stopping and is determined to be the first evacuation floor for initial stopping. After the occupants at evacuation floor F(n+2) enter the elevator car during initial stopping, the elevator car still has a large remaining capacity. In the process of further traveling downward, the elevator car performs intermediate stopping at evacuation floor F(n−2). After the remaining occupants at evacuation floor F(n−2) enter the elevator car, the elevator car continues to travel downward to the safe floor Fdis.

Therefore, the elevator car can safely transport occupants from evacuation floors F(n+1), F(n+2), Fn, F(n−1), and F(n−2) to the safe floor through three round trips. It is to be understood that if the evacuation method in the prior art were used, at least four round trips of the elevator car would be needed. Therefore, the efficiency of the entire evacuation process for the plurality of evacuation floors in FIG. 6 is significantly improved, and the evacuation process is safe and reliable.

It should be noted that the control module 130 in the above embodiment of the present invention can be implemented by a controller which run computer program instructions. For example, these computer program instructions may be provided to a processor of a general-purpose computer, a special-purpose computer, or another programmable data processing device to form the controller or the control module 130 in the embodiment of the present invention. Moreover, the processor of the computer or another programmable data processing device may execute these instructions to create units or components for implementing functions/operations designated in these flowcharts and/or blocks and/or one or more of the flowchart blocks.

Moreover, these computer program instructions may be stored in a computer readable memory. These instructions can instruct the computer or another programmable processor to implement the functions in specific manners, such that these instructions stored in the computer readable memory construct a product including instruction components for implementing functions/operations specified in one or more blocks of the flowcharts and/or block diagrams.

It should be further noted that in some alternative implementations, the functions/operations shown in the blocks may not take place according to the sequence shown in the flowchart. For example, two blocks shown sequentially may be performed basically at the same time, or these blocks sometimes may be performed in a reversed order. This specifically depends on the functions/operations involved.

It should be noted that elements (including the flowcharts and block diagrams in the accompanying drawings) disclosed and depicted in this specification refer to logic boundaries between elements. However, according to software or hardware engineering practices, the depicted elements and functions thereof can be executed on a machine by using a computer executable medium. The computer executable medium has a processor that can execute program instructions stored thereon. The program instructions serve as a single-chip software structure, an independent software module, or a module using an external program, code, service or the like, or any combination thereof. Moreover, all these execution solutions may fall within the scope of the present disclosure.

Although different non-limitative implementation solutions have components that are specifically illustrated, the implementation solutions of the present invention are not limited to these specific combinations. Some of the components or features from any non-limitative implementation solution may be combined with features or components from any other non-limitative implementation solution.

Although specific step sequences are shown, disclosed, and required, it should be understood that the steps may be implemented in any sequence, separated, or combined, and they will still benefit from the present disclosure unless otherwise specified.

The foregoing descriptions are exemplary and are not defined to be limitative. Various non-limitative implementation solutions are disclosed in this specification; however, according to the foregoing instruction, those of ordinary skill in the art will be aware that various modifications and variations will fall within the scope of the appended claims. Therefore, it should be understood that disclosure content other than that specifically disclosed can be implemented within the scope of the appended claims. Therefore, the appended claims should be studied to determine the real scope and content.

What is claimed is:

1. An elevator control device for controlling the travel of one or more elevator cars of an elevator system, wherein a control module of the elevator control device is configured to control, according to occupant information and disaster information of a plurality of evacuation floors, stopping of the elevator car at at least one of the plurality of evacuation floors.

2. The elevator control device according to claim 1, further comprising:
an occupant information acquiring unit configured to acquire the occupant information of the plurality of evacuation floors; and
a disaster information acquiring unit configured to acquire the disaster information of the plurality of evacuation floors.

3. The elevator control device according to claim 2, wherein the occupant information acquiring unit comprises:
an occupant information capturing component installed at a corresponding position on at least one of the plurality of evacuation floors and configured to capture image information of an area corresponding to the position; and
an occupant information analyzing component configured to analyze image information captured by one or more occupant information capturing components to acquire the occupant information of the corresponding evacuation floor.

4. The elevator control device according to claim 1, wherein the occupant information comprises occupant quantity information, or further comprises at least one of the following types of information: occupant distribution information, occupant flow information, and occupant feature information.

5. The elevator control device according to claim 2, wherein the disaster information comprises at least one of the following types of information: disaster type information, threat position information, disaster spreading information, and threat development trend information.

6. The elevator control device according to claim 1, wherein the control module is further configured to dynamically adjust a stopping strategy for the elevator car corresponding to at least one of the plurality of evacuation floors according to real-time changes in the occupant information and the disaster information of the plurality of evacuation floors.

7. The elevator control device according to claim 1, wherein the control module is configured to control the travel of the elevator car from a first evacuation floor for initial stopping to a safe floor, and is further configured to control, according to current occupant information and disaster information of the plurality of evacuation floors, whether the elevator car performs intermediate stopping at one or more second evacuation floors other than the first evacuation floor among the plurality of evacuation floors.

8. The elevator control device according to claim 1, wherein the control module is further configured to: control, according to the current remaining capacity of the elevator car, the stopping of the elevator car at at least one of the plurality of evacuation floors.

9. The elevator control device according to claim 8, wherein the control module is further configured to: when the current remaining capacity of the elevator car during initial stopping or intermediate stopping is greater than or equal to a first predetermined value, control the elevator car to continue stopping for a first predetermined time period.

10. The elevator control device according to claim 8, wherein the control module is further configured to: when the current remaining capacity of the elevator car after initial stopping is greater than or equal to a second predetermined value, control whether the elevator car performs intermediate stopping at the second evacuation floor at least based on occupant information and disaster information corresponding to the second evacuation floor.

11. The elevator control device according to claim 10, wherein the control module is further configured to: respectively determine, based on real-time occupant information and disaster information corresponding to a plurality of second evacuation floors, priorities of the second evacuation floors for intermediate stopping.

12. The elevator control device according to claim 11, wherein the control module is further configured to: determine, based on the priorities of the plurality of second evacuation floors for intermediate stopping, a second evacuation floor at which the elevator car needs to intermediately stop in the current process of traveling from the first evacuation floor for initial stopping to the safe floor, and/or determine, based on the priorities of the plurality of second evacuation floors for intermediate stopping, a sequence for intermediate stopping.

13. The elevator control device according to claim 7, wherein the control module is further configured to: determine, based on real-time occupant information and disaster information corresponding to the plurality of evacuation floors, priorities of the plurality of evacuation floors as the first evacuation floor for initial stopping.

14. The elevator control device according to claim 13, wherein the control module is further configured to: determine a sequence of initial stopping based on the priorities for initial stopping.

15. An elevator system, comprising an elevator car and the elevator control device according to claim 1.

16. An elevator control method for controlling the travel of one or more elevator cars of an elevator system, the elevator control method comprising: controlling, according to occupant information and disaster information of a plurality of evacuation floors, stopping of the elevator car at at least one of the plurality of evacuation floors.

17. The elevator control method according to claim 16, further comprising a step of:
receiving the occupant information and the disaster information of the plurality of evacuation floors.

18. The elevator control method according to claim 16, wherein the occupant information comprises occupant quantity information, or further comprises at least one of the following types of information: occupant distribution information, occupant flow information, and occupant feature information.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. An elevator control device, comprising a memory, a processor, and a computer program stored in the memory and executable on the processor, wherein when the processor executes the program, the steps of the elevator control method according to claim 16 are implemented.

32. A computer readable storage medium storing a computer program, wherein the program is executed by a processor to implement the steps of the elevator control method according to claim 16.
